(19) United States
(12) Patent Application Publication
(10) Pub. No.: US 2012/0111215 A1
(43) Pub. Date: May 10, 2012

(54) METHOD FOR PASTY INK FLEXOGRAPHY PRINTING ASSOCIATED TO INK LOAD VARIATION DUE TO THERMAL MODULATION

(76) Inventor: Valter Marques Baptista, São Paulo (BR)

(21) Appl. No.: 13/318,714

(22) PCT Filed: May 6, 2009
(86) PCT No.: PCT/BR09/00122

§ 371 Date: Nov. 3, 2011

(51) Int. Cl. B41F 33/00

(52) U.S. Cl. 101/483

(57) ABSTRACT

The present invention refers to a “Method for pasty ink flexography printing associated to ink load variation due to thermal modulation” developed to allow a novel printing technology in central drum flexography equipments with high viscosity inks and 100% solids with later UV radiation (UV) or electron beam (EB) curing. The invention provides a central drum flexographic printing system which by means of modifications in the inking systems allows applying high viscosity inks with no intermediate drying or curing system between the successive appliance of several colors having only the final drying with a curing device, preferably based on electron beam or optionally by actinic radiation (UV light).

The present application refers to a METHOD FOR PASTY INK FLEXOGRAPHY PRINTING ASSOCIATED TO INK LOAD VARIATION DUE TO THERMAL MODULATION developed to allow a novel printing technology in central drum flexography equipments with high viscosity inks and 100% solids with later UV radiation (UV) or electron beam (EB) curing.

### BACKGROUND OF THE INVENTION

1. Field of the Invention

The present application relates to printing systems and more particularly to a central drum printing system with an inking system operable with high viscosity inks.

2. Prior Art

There are two ink technologies which can be generically classified as well established techniques for printing processes:

1—Thermal drying:

a. A widely known process, responding for the production of more than 95% of all printed material based on liquid inks.

b. Technique based on solvent evaporation by means of a hot air blow after a first deposition of wet ink layer on a substrate.

c. Holds approximately 100% of printings with liquid inks in equipments over 50 cm width.

d. Generally present viscosities between 50 cPs and 500 cPs.

2—Radiation curing

Despite the existence of both technology and equipment operable with electron beam, the vast majority of printers based on radiation curing do operate with the UV system.

Almost all equipments use the so-called Narrow Band or printing width up to 50 cm, particularly in the self-adhesive label and stamp segment, wherein the substrate cost (paper or self-adhesive film) allowed the use of a much expensive ink than the solvent inks which, on the other hand, presented superior results in terms of waste and printing quality.

Normally present viscosities between 250 cPs and 2500 cPs.

The thermal drying has the disadvantage of having solvents that often present lower printing quality than the systems using ultraviolet (UV) radiation cure and also the inconvenient of liberation great amounts of volatile organic compounds (VOC's) that contribute to atmospheric pollution.

UV systems, on the other hand, present superior printing quality but also have high ink costs and certain incompatibilities with specific applications, mainly regarding the foodstuff, pharmaceutical and cosmetic areas due to the presence of photo-initiators and odor formation in the printed packages.

An example which does not have most of the abovementioned inconveniences is the continuous offset printing, currently better represented by the variable repeat printers that can use curing based on electron bombardment equipments only at the end thereof.

The great advantage of these systems is the lack of any other intermediate drying and/or curing system. However, the perfect setting of the whole system, particularly the amount of wetting water becomes of paramount importance for obtaining good printing quality when using non-absorbent substrates, since they do not absorb ink like papers do.

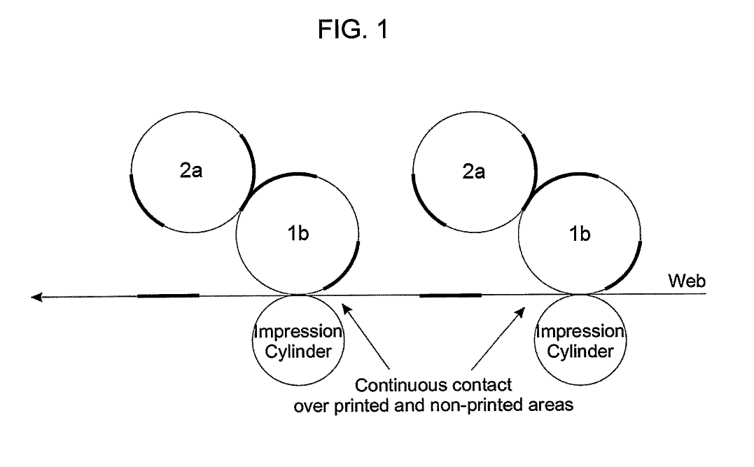

Inks that remain in substrate surfaces are more sensitive to deformation damages due to successive printing of colors since, in offset printing; the rubber cylinder which delivers the image touches the entire surface of the substrate, even in areas that do not comprise ink, thus potentially causing the withdrawal of the previously printed ink as illustrated on Fig.1.

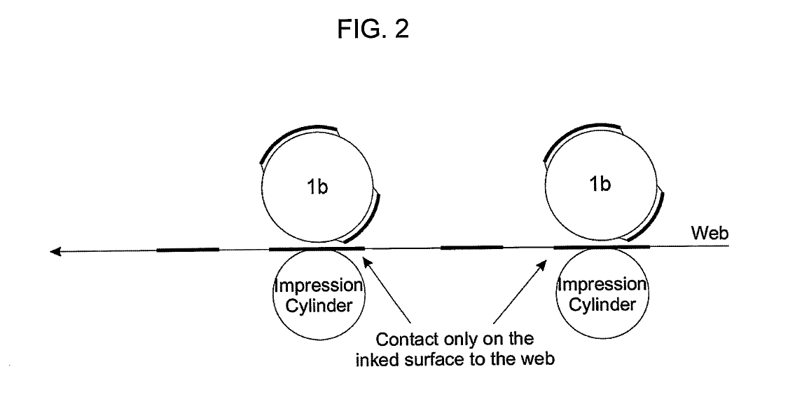

In the case of flexography, there is the advantage that the sole areas touching the substrate are the respective color printing areas, said areas' surfaces always being covered with ink, as illustrated on FIG. 2, this being indeed beneficial to the printing process since only ink touches the substrate or other pre-printed ink layers, this being of utmost relevance for the present invention.

Hence, the present invention provides the combination of advantages particular to each of these processes in a novel printing system able to provide the market with a high quality printing alternative which is free of organic volatile compounds (VOC's).

The major challenge for achieving such an objective is assembling a inking system able to operate in a central drum flexographic printer with inks having viscosities varying from 100 and 500 Poises, far different from the current standard around 200 to 300 cPs (centipoise), i.e., 100 times lesser.

Some authors have suggested certain solutions such as the use of flexographic inking systems almost identical to the current ones, although having a thermal treatment which reduces the ink viscosity during application and with the increase thereof after application in the final substrate, thus allowing the acceptance of the subsequent color to be printed providing an image with good quality as disclosed in the U.S. Pat. No. 5,690,028.

The basic problem in using temperature for obtaining better printing trapping, specially in the suggested equipment assemblies, is that for encapsulated “doctor Blade” and pump systems to work properly the viscosity would have to be relatively low, this implying either in starting with relatively low viscosity inks or in a dramatic increase in temperature that always make a process hard to control.

Another side effect which is not considered in said patent is that fact that ink load transferring occurs in systems having Anilox cylinders when a Sharp oscillation in viscosity is observed.

This variation of the Anilox ink load transfer due to viscosity variation could be explained by the lesser adherence of more liquid inks in the surfaces of the Anilox cells allowing a higher ink volume to leave said Anilox towards the substrate when viscosities decrease.

This aspect can be noted even in ultraviolet curing inks that, upon heating during the printing job present increase in printing density which demand lacquer to cut the colors densities sometimes up to 25% to return to standard colors.

Thus, the use of temperature as an aspect of controlling the wet trapping of several ink layers aiming a stable and constant result required by modern printing processes is highly laborious and requires a massive control apparatus so as to assure stability.

The present invention is based in the wet-on-wet printing capability in the own starting viscosity of the inks, allowing the printing equipment to manipulate inks with such viscosities by means of mechanical and electro-electronically resources that do not affect the ink viscosity and also covers the possibility of minor adjustments in the transferred volumes based in small and controllable thermal changes in said inks.

Another fundamental concept difference is the fact that even if temperature could be used as a load modulation factor, even if a previous ink have been applied, for example in the third printing station with a given temperature so as to increase the load, the fourth station ink could be applied at room temperature and is shall find a receptive means on the previously applied ink that will be in a previously set viscosity and tack that will be higher than the forth station.

Also in the routine printing practice, specially during equipment setups, there are several equipment stops and restarts which in turn require the necessary thermal setting even of the plate cylinder so as to process disclosed on the U.S. Pat. No. 5,690,028, could provide an uniform result throughout all the production steps.

Nowadays, since the vast majority of the printing devices have sleeve technology wherein the Anilox cylinder and plate holders are tubular sleeves and are regularly engaged in fixed mandrills in the device in one side in balance, the thermal treating becomes even more complex since the discontinuity of the printing set and the risk of differentiate dilations to cause system imprecision.

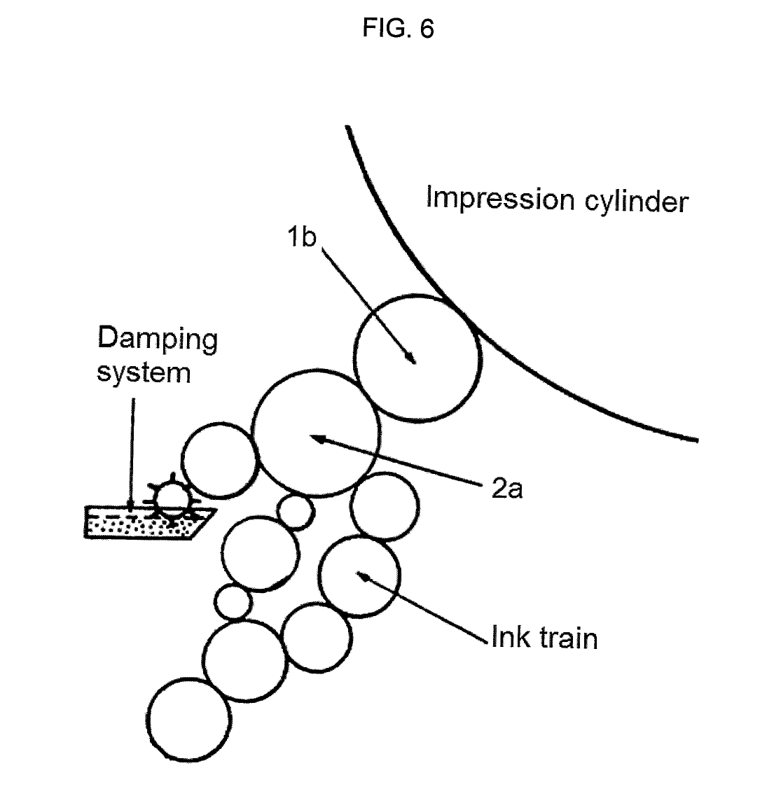

Also, on the other hand, some specialists have been proposing inking systems relatively close to the offset printing systems, with a multiple roll system as illustrated in FIG. 6.

Despite the great efficiency of the inking systems, the size and complexity thereof could cause a great difficulty for the fitting thereof in the relatively restricted space of current central drum flexographic printers that normally comprise from 8 to 12 colors around a central drum having a diameter of about 2 meters, this drastically restricting the space between colors for a classical offset inking system.

Hence, keeping the concepts as close as possible of the flexographic inking system but also in working conditions for pasty inks has proven to be the best way for achieving the objective of working with viscous inks in flexography.

### SUMMARY OF THE INVENTION

Present invention provides a central drum flexographic printing system which by means of modifications in the inking systems allows applying high viscosity inks with no intermediate drying or curing system between the successive appliance of several colors having only the final drying with a curing device, preferably based on electron beam or optionally by actinic radiation (UV light).

### DETAILED DESCRIPTION OF THE INVENTION

The present invention aims creating a flexographic printing system with a central drum equipment which is by means of proper inking systems and with the use of viscous inks is able to produce printings with wet on wet color superimposition with cure at the end of the process by electron acceleration (EB) systems or UV light.

In addition, the use of high viscosity inks allows controlling the liberation thereof from the (alveolus of the) Anilox cells by means of temperature change which in turn allows a novel ink deposition variation even in the same Anilox cylinder.

The concept explored herein is quite close to the traditional so-called dry offset or “letterpress”, however using more flexible plates and with the direct printing instead of the indirect printing thereof.

FIGS. 1 AND 2

FIG. 1 shows an offset printing system scheme pointing out the fact that in this printing process the ink is transferred to the substrate by means of a rubber covered cylinder known as Blanket Cylinder (1b), which is plain since in the offset process the separation of the image areas and non-image areas is done by the physical principle of repulsion between water (polar) and oil (non-polar). Hence, differently from the flexography printing process from FIG. 2 which does use topography to separate areas that shall be printed (image areas) from the ones that shall not be printed (non-image areas), as shown in the plate cylinder (2a) scheme, while printing the rubber from the blanket cylinder (1b) shall touch all the surface of the S substrate, even in areas where the blanket cylinder (1b) has no ink. On the other hand, in a flexography printing process (FIG. 2), only inked areas shall touch the S substrate.

In the offset case, when a suitable humidity level is present over the non-inked surface of the blanket cylinder (1b) there will be more difficulty for the pre-printed ink in the S substrate to spot the non-inked surface of the blanket cylinder (1b), thus preventing the removal of the pre-printed ink and allowing a proper printing.

However, when lacking proper humidity, one can expect removal of the pre-printed ink by the subsequent blanket cylinder (1b), this causing variable printing defects.

In the case of a flexographic printing process, since the inked areas the only ones actually touching the surface of the S substrate, either inked or non-inked, the ink layer over the surface of the plate cylinder (2a) will always present lesser probability of removing the pre-printed ink, considering that the ink has less potential of said removal than solid surfaces.

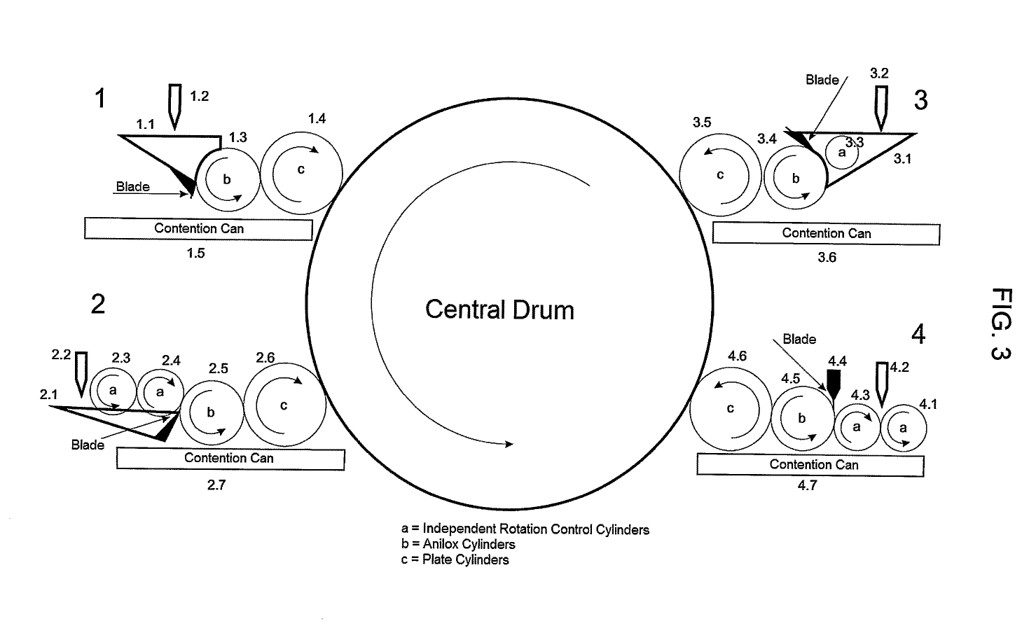

FIG. 3

Drawing 1, presented in FIG. 3, is one of the examples of the possible assembly of an inking system able to handle high viscosity inks in central drum flexography.

The ink is either manually added or added by a pumping system as the one available in solventless lamination equipments by the tip (1.2) in the inktray (1.1). The inktray (1.1) is molded onto the Anilox cylinder (1.3) so that there is no ink leakage, normally by means of a soft pressure in the contact areas thereof, which are covered in proper material to avoid wearing the Anilox ceramics. Said proper materials are, for example, Nylon, polypropylene, Vitton, etc.

To the lower part of the inktray (1.1) the blade (d) is added, said blade shall remove all the ink excess from the Anilox surface, leaving ink only inside the Anilox cells. Normally, the setting of the blade (d) pressure so as to achieve proper cleaning of the Anilox cylinder surface is done by means of:

a) Approaching or parting all the inktray (1.1) assembly;

b) Replacing the blade (d) positioning on the inktray (1.1) so as to either approach or part the blade (d) from the Anilox cylinder, modulating the cleaning pressure of the Anilox cylinder (1.3) from the blade (d);

c) Rotating the inktray assembly (1.1) around the support thereof so as to either enhance or lower the pressure from the blade (d) over the Anilox cylinder (1.3).

After the cleaning of the Anilox cylinder surface, it shall ink the plate attached over the cylinder (1.4) that in turn will print the substrate leaning over the central drum.

Drawing 2 of the FIG. 3 represents another assembly possibility of the inking system for a central drum flexographic equipment, for handling high viscosity inks. Differently from drawing 1, the presence of cylinders 2.3 and 2.4 allows ink pre-dosing so as to ease the hydraulic pressure of the ink over the blade (d), caused by the rotation speed of the Anilox cylinder (1.3) against the blade (d). In the case of drawing 2, Said pressure is limited by the reduction on the ink layer that reaches the blade (d) by means of the pressure between cylinders 2.3 and 2.4, which can rotate in variable speeds which are independent from the printer rotation speed.

Another advantage of drawing 2 is the possibility of ink thermal conditioning by means of the heating of cylinders 2.3 and 2.4.

The thin ink layer which escapes from the pressure between cylinders 2.3 and 2.4 is laid with low pressure over the Anilox cylinder 2.5 surface, which has its surface cleaned by the blade presented in the body of inktray (2.1) set, allowing ink only inside the Anilox cylinder (2.5) cells that will subsequently ink the surface of the cylinder plate (2.6) which in turn will transfer the ink to the substrate leaning over the central drum.

Drawing 3 of FIG. 3 represents an assembly possibility for the external inking sets of central drum printers consisting of an inktray (3.1) either manually or automatically fed by the solventless-like feeding tip (3.2), an ink volume limiting cylinder (3.3), an Anilox cylinder (3.4) and the plate cylinder (3.5).

The addition of the ink limiting cylinder (3.3) is essential in this configuration since the absence thereof would implicate in ink overflowing out of the inktray (3.1) due to the Anilox cylinder (3.4) rotation. The presence of the limiting cylinder (3.3) only allows the passage of a thin ink layer over the surface of the Anilox cylinder (3.4), easing the cleaning process by the blade (d) fixed in the inktray (3.1) structure just ahead. By means of the rotation control of the limiting cylinder (3.3), the ink excess from the blade (d) cleaning is than returned to the inktray (3.1).

In the same way as described in scheme 2, the presence of the limiting cylinder (3.3) allows thermal conditioning with consequent conditioning of the ink that is permanently in contact thereof, this allowing the variation on the layer of transferred ink.

Drawing 4 of FIG. 3 presents an alternative embodiment which lacks the inktray, the inktray that will receive the manual or automatic ink feeding of the solventless type constituting the contact between rolls 4.1 and 4.4. In practice, the inktray system proposed herein is also identical to the system used in solventless laminators, with the addition of the limiters (4.3), which normally are made of Nylon so as to avoid leaking ink from the sides thereof.

Ink deposited between cylinders 4.1 and 4.4 has its appliance control over the Anilox cylinder (4.6) dosed by the pressure between cylinders (4.1 and 4.4), wherein the ink excess removed from the surface of the Anilox cylinder (4.6) by the blade (d) is returned to the reservoir formed by cylinders 4.1 and 4.4 due to the rotation of cylinder 4.4.

The Anilox cylinder (4.6) which was cleaned by the blade (d) and having ink only in the Anilox cells will than ink the plate cylinder (4.7) that in turn will transfer the ink to the substrate leaning over the central drum.

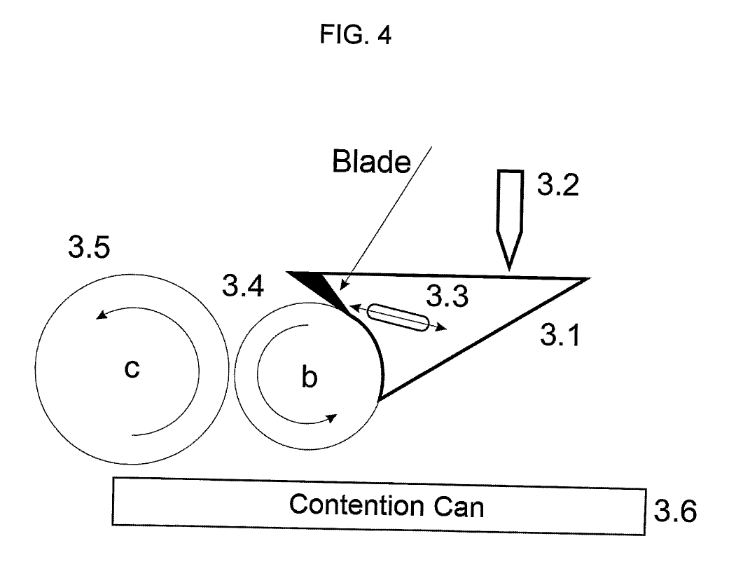

FIG. 4

The scheme in FIG. 4 presents an alternative to the ink limiting cylinder (3.3) of drawing 4 of FIG. 3.

The replacement of said cylinder by a shield (4.3) with a positioning adjustment possibility regarding the Anilox cylinder (4.4) and with the necessary slope so as to allow that the ink excess removed by the blade (d) returns to the inktray (4.1).

The possibility of thermal conditioning remains, but it would require the conditioning of the inktray itself or the enhancement of the size of the limiter (4.3) so as to allow enough contact area with the ink and space for passing the thermal fluid or insertion of resistances.

Additionally, the replacement of a cylinder by a non-rotating piece shall imply in having practical means for the removal thereof during the cleaning operation.

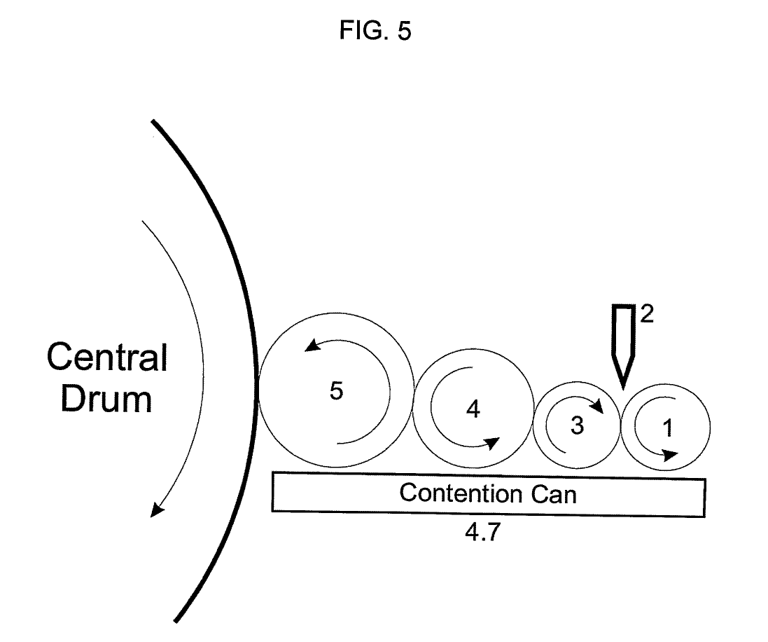

FIG. 5

The scheme in FIG. 5 demonstrates the option of substituting the Anilox cylinder inking system by a truly solventless laminating-type inking system, wherein the cylinder (5.4) which has the function of inking the plate cylinder (5.5) no longer is an engraved cylinder, but just a cylinder like the specially lapidated from the solventless laminators—a very hard and perfect round cylinder usually made with special alloy to be very resistant. The major complexity in this case is to assure the refilling and homogenizing of the ink layer of the cylinder surface (5.4), which after the inking of the plate cylinder (5.5) will have areas with a full ink layer and others with ink partially removed by the plate cylinder (5.5). The homogeneous ink layer may be obtained by the rotation difference between the dosing cylinders (5.3) and the inker (5.4), so that the occurring spatulation will assure an even application.

Anyway, differently from other suggested alternatives, the removal of the Anilox cylinder implies in that the ink shall concentrate in the cylinder surface instead of the Anilox cells, which could negatively impact the dot printing.

The use of extra-high inking power inks might partially compensate the adverse factor, since the higher the ink power of the used ink the lower would be the ink layer necessary for the required color density.

The working scheme is identical to the one proposed in the drawing 4 of FIG. 3, but without the presence of the Anilox and blade (d) and with the dosing cylinder (5.3), with the possibility of speed variations.

FIG. 6

FIG. 6 represents a conventional offset printing or lithography system, and the meaning thereof is to illustrate the amount of cylinders (ink train) necessary for a proper ink distribution and homogenization required by the system, which is not ideal for the low space availability and accessibility of the flexographic system with central drum.

In order to turn high viscosity inks operable in central drum flexographic equipments, several mechanical modifications are implied; FIGS. 3 and 4 illustration and giving support for a better understanding of said modifications.

Firstly, quite differently from the current encapsulated “doctor blade” system provided in all of the equipments of the market that acts equally in both inner and outer parts of the printer, wherein Anilox cylinders roll in opposite directions, for the use of high viscosity inks the encapsulated “doctor blade” system is not recommended which in turn leads to deep modification that shall generate asymmetry between inner and outer inking systems of the printer.

FIG. 3 illustrates some possible mechanical solutions for working with high viscosity ink system.

The following examples serve to provide further appreciation of the invention but are not meant in any way to restrict the scope of the invention.

According to the counterclockwise numbering:

Examples 1 and 2 refer to the inner part of the printer and configure the fewer required modifications for allowing the high viscosity ink printing system to work.

In practice, the scheme 1 very much resembles an offset system inker but rather having a cleaning blade for the Anilox cylinder surface.

Similar solutions were already adopted in flexographic devices such as Stack Type narrow and middle band with great success for UV inks since they allow handling inks that represent broader formulas and characteristics of said inks.

The weakest point of scheme 1 is the greater difficulty in implementing of volume variation control of the ink applied by means of temperature since in modern printing devices it is not recommended to induce thermal variation in the Anilox cylinders, considering that the vast majority of the printers uses sleeves systems either for plate cylinders or for Anilox ones and it is not desirable to add more complexity or costs to these already expensive and sophisticated elements.

The thermal modulation condition for inks directly on the inker remains and since the inker according to scheme 1 is fairly simple the possibility of thermal exchange with no need for additional elements such as other cylinders is therefore limited.

Scheme 2 represents an alternative for the solution of the two necessities pointed out herein since it not only serves well for handling high viscosity inks but also presents the possibility of thermal control by means of controlling the temperature of the cylinders 2.3 and 2.4, which can easily control the ink transfer variation.

For a more effective inking control and so as to avoid ink bypassing the inking group due to the speed thereof all the additional cylinders used, in addition to the Anilox and the cliché holder which are standard for printers, it is desirable that the additional cylinders allowing the handling of the high viscosity inks, labeled in FIG. 3 as “a”, do have reduced or controlled speed irrespectively to said Anilox and plate cylinders ones.

Schemes 3 and 4 present possible simultaneous solutions for controlling volume transfer and handling of high viscosity inks as constructive suggestions for the outer side of the printer.

Differently from schemes 1 and 2, wherein blades are located in the lower part of the reservoir in light of the cylinder rotation sense of the Anilox cylinders, in schemes 3 and 4 the blades are located in the upper part thereof being either capable of integrating the reservoir structure (scheme 3) or in the case of scheme 4, which lacks a reservoir using the same “Solventless” laminators principle using their own rolls to create the reservoir, the blade becomes an independent element of the reservoir.

Considering that in practice the roll pressure acting on the Anilox cylinders can be severely diminished or even lacking contact and solely defining a thin ink layer on the surface of the Anilox cylinder to allow the constant reposition of the consumed ink, cylinders directly in contact with the Anilox could be either made of synthetic or metallic material.

Being synthetic material the option, the disadvantage relies on the shorter work life that is not desirable for equipments with the flexographic printers work load.

In case of metal cylinders, a delimiting system which avoids direct contact between said cylinders and the Anilox cylinder is recommended, a short opening of about 0.01 to 0.2 mm remaining therein, for example.

In the specific case of scheme 3, it is necessary to place a cylinder or other limiting device so that the Anilox cylinder rotation does not lead to moving all the ink from the inker towards the blade. In case a cylinder is adopted, it could be either fixed or mobile, turning clockwise or counterclockwise to ease the transfer control and cleaning thereof; in simpler systems however a limiting bar (3.3) can substitute the cylinder, as illustrated in FIG. 4.

In the FIG. 5 it is possible define a new possibility for inking system, as mentioned previously in the explanation of Scheme 4 of FIG. 3, much more than use the solventless concept just to create the reservoir of ink, it is possible to use a completely concept of solventless system and even remove the anilox roll out of the inking system.

These may require a specific modification on cylinder 3 of the scheme of FIG. 5, since the only way to warrant the right and uniform ink covering on the surface of roll 4 (FIG. 5) is using the different periphery speed between those two rolls (3 and 4).

The basics of the new principle of solventless inking are that the ink is contained between cylinders numbered 1 and 3. Usually cylinder 1 can be fixed or move slowly in the sense of arrow.

The speed of cylinder 3 is controlled and usually rotates at lower speed than the cylinder 4. This difference in the periphery speed create a spatulation effect on the layer of the ink on the surface of cylinder 4, necessary to ensure a uniformity layer of ink, with reposition of the ink removed by the printing plate 5 in the previous rotation.

A good result is expected for block and maybe a little bigger dot gain in terms of dot printing.

Differently from liquid ink systems and in the same way as offset or letterpress printing processes or even in closed systems, a great volume of circulating ink is not necessary since there is no solvent to be evaporated.

This allows high economy on ink since in cases of small printed areas or drafts the viscous ink handling systems allow working with severely reduced volumes such as one or two kilograms of ink.

Printers could be automatically loaded in the same way solventless laminators do, by means of a pumping system which is fed by a level sensor that aids the work of the printers, especially in cases of huge runs and of high volume ink demanding L 0 colors.

Regarding the thermal modulated variation in ink load, the recommended variation range in the ink temperature is between room temperature and plus 25° C. Despite greater variations being allowed, the control thereof and the ink handling itself at higher temperatures becomes more complex, a variation below 25° C. being enough for important printing density adjusting.

For high viscosity ink flexographic printing it is desirable that the central drum temperature be the lowest possible one, provided no water condensation over the substrate or other printing defects is observed.

Normally the central drum of flexographic printers is kept between 28° C. and 32° C., but the use of temperatures between 22° C. and 26° C. is herein recommended, this certainly enhancing the use of the present invention on wet over wet printing.

Tack regression is the routine way for improving printing quality by means of a better color trapping.

Such a technique is widely used in offset, especially in the printing of non-absorbing substrates, and consists on applying inks with both decreasing tack and viscosity so as to avoid the stripping of previous ink by the subsequent one.

Hence, for example, in the case of an Opaltone printing system the sequence hereinbelow could be used, according to the suggested viscosity gradient:

| | | Viscosity | Tack |
|---|---|---|---|
| Order | Color | (P@25° C.) | (400 rpm/1 min) |
| 1 | Yellow | 300 | 14.0 |
| 2 | Magenta | 275 | 13.0 |
| 3 | Cyan | 250 | 12.0 |
| 4 | Black | 225 | 11.0 |
| 5 | Red | 200 | 10.0 |
| 6 | Green | 175 | 9.0 |
| 7 | Violet | 150 | 8.0 |

The use of decreasing tack and viscosity system strongly benefits the wet on wet printing capability, since low tack and viscous inks have lower possibility of stripping previously printed inks even in very thin layers wherein said stripping tends to be stronger.

Thus, the interaction of inking systems operable with high viscosity inks together with printing ink tack and viscosity settings, despite bringing certain limitations on the sequence or order of color choice, impressively benefits printing quality and ease.

Moreover, as previously mentioned, if in one hand the shaped forms of the flexographic printing process have more difficulties to port the same printing qualities as the offset printing system forms, on the other hand they herein do provide the advantage of only allowing inked areas to contact either the printable substrate as the previously printed ink layers.

This assures that only ink shall contact ink which in turn applied to the tack regression concept will always make a less viscous and less tacky ink to contact another highly viscous and tacky one.

Although there is great interference of the layer thickness on such interactions, a proper image management from pre-press, with the respective color separation thereof, and the correct printing input order selection could mitigate adverse effects of applying lower ink layers over higher ink layers previously printed.

The additional gains which derive from the use of high viscosity inks in flexography tend to strongly compensate such limitations. Among the main advantages the following can be pointed out:

a) sharp reduction of the dot gain;

b) reduction of the applied ink so as to obtain a certain density as a function of the high concentration of ink pigments;

c) enhance on the image definition;

d) reduction in the residual ink reuptake and the end of production, since the proposed inking systems operate with reduced volumes of ink when compared with liquid inks;

e) allowing minor adjustments on ink volumes transferred by thermal modulation.

1. Method for central drum flexographic printing comprising the steps of:
a. modifying the inking system for excluding the actual enclosed doctor blade system, the pumping system and adding a new inking systems that allow the use of high viscosity inks;
b. enabling wet on wet printing due to the ability of said high viscosity inks in bearing color superposition;
c. curing solely in the final part of the printing process by means of radiation;

2. Method according to claim 1, wherein the high viscosity ink comprises inks having viscosity from about 50 Poises and 500 Poises, preferably in a range between about 80 Poises to 250 Poises.

3. Method according to claim 1, wherein the high viscosity ink comprises inks free of organic volatile compounds (VOC's) in the working temperatures and that are curable by radiation.

4. Method according to claim 1, wherein the modifying the inking system comprises initially excluding the traditional doctor blade system and the pumping ink recirculation system and tanks and adding inking systems allowing the use of inks with viscosities 100 times higher than the usual viscosities between 50 Poises and 500 Poises of the traditional flexographic systems according, but not limited to, FIG. 3 and FIG. 4.

5. Method according to claim 1, wherein the wet on wet printing comprises applying successive layers of ink in the substrates without aid of either drying or curing intermediate process, neither thermal nor by any means of radiation and wherein the proper image is obtained based on the high viscosity ink ability of bearing successive superimposition of colors therein.

6. Method according to claim 1, wherein the radiation is either ultraviolet light or an electron beam.

7. Method according to claim 1, wherein a variation of ink load by means of temperature modulation is obtained by varying the ink deposition of the same Anilox cylinder due to the variation of the ink transfer rate in light of the fluidification due to increase on the ink temperature.

8. Method according to claim 1, wherein the increase in ink temperature by means of any external influence is comprised between 25° C. and 50° C. due to ease in operation and higher ink stability at lower temperatures.

9. Method according to claim 9, wherein said external influence for the temperature control comprises, but is not limited to, electrical resistance, infrared radiation, hot water, thermal oil, hot air and the like.

10. Method according to claim 1, wherein a decreasing tack and decreasing viscosity gradient is used and comprises the continuous lowering on the values of these two ink properties according to the equipment color sequence so as to assure that the subsequent color will always have tack and viscosity which are lower than the previous one printed, this aiding the printing process.

11. Use of a new solventless inking concept wherein no Anilox rolls are required to promote the inking of printing plate, with the different periphery speed between cylinders to regulate the amount of ink to be transferred between the last inking cylinder and the printing plate.
